(19) United States
(12) Patent Application Publication
(10) Pub. No.: US 2025/0283801 A1
(43) Pub. Date: Sep. 11, 2025

(54) In-situ fretting corrosion fatigue testing machine and method based on synchrotron radiation diffraction and three-dimensional (3D) imaging

(71) Applicant: Southwest Jiaotong University, Chengdu (CN)

(72) Inventors: Ni AO, Chengdu (CN); Jingrui ZHANG, Chengdu (CN); Yao XIAO, Chengdu (CN); Shengchuan WU, Chengdu (CN); Songquan TANG, Chengdu (CN); Haoqiang HUANG, Chengdu (CN); Guozheng KANG, Chengdu (CN)

(73) Assignee: Southwest Jiaotong University, Chengdu (CN)

(21) Appl. No.: 19/071,811

(22) Filed: Mar. 6, 2025

(30) Foreign Application Priority Data
Mar. 7, 2024 (CN) 2024102609874

(51) Int. Cl. G01N 17/00; G01N 3/04; G01N 3/10; G01N 3/36; G01N 3/38; G01N 23/04

(52) U.S. Cl. CPC G01N 17/002; G01N 3/04; G01N 3/10; G01N 3/36; G01N 3/38; G01N 23/04; G01N 2203/0007; G01N 2203/0073; G01N 2203/0226; G01N 2203/024; G01N 2223/1016; G01N 2223/203; G01N 2223/3306

(57) ABSTRACT

An in-situ fretting corrosion fatigue testing machine based on synchrotron radiation diffraction and three-dimensional (3D) imaging includes an axial fatigue loading system, a fretting loading system, and a corrosion environment control system, where the axial fatigue loading system includes a driving device, a load control device, and a load sensing device; the load sensing device is configured to measure an axial force and a normal force in real time; the driving device is configured to drive the load control device, thereby achieving axial displacement of the load control device; the load control device is configured to carry out axial fatigue loading of a specimen; and the fretting loading system includes a fretting wear device. The testing machine achieves real-time 3D imaging characterization of wear spot and crack morphology of a material in a fretting corrosion environment, as well as characterization of a residual stress evolution law.

### CROSS REFERENCE TO THE RELATED APPLICATIONS

This application is based upon and claims priority to Chinese Patent Application No. 202410260987.4, filed on Mar. 7, 2024, the entire contents of which are incorporated herein by reference.

### TECHNICAL FIELD

The present disclosure belongs to the field of fretting corrosion fatigue testing, and relates to an in-situ fretting corrosion fatigue testing machine and method based on synchrotron radiation diffraction and imaging technology.

### BACKGROUND

Fretting fatigue refers to a failure mode in which the contact interface undergoes micron-scale relative motion due to external alternating stress on the contact body, which accelerates the initiation and propagation of fatigue cracks, thereby affecting fatigue strength and life. When fretting fatigue and corrosion damage coexist, their effects are not simply superimposed. On the contrary, there is a significant interaction between fretting fatigue and corrosion damage, with the strength exceeding the result of the simple combined action of the alternating stress and corrosive medium. Due to the influence of the corrosive medium, the fretting fatigue life of the material is significantly reduced, which poses a great challenge to the safe use of major engineering equipment. Fretting corrosion fatigue is widely present in many national economic industries such as marine machinery, aerospace, and rail transportation. Especially under harsh natural conditions such as ocean atmosphere and urban acid rain, the fretting corrosion fatigue damage of components is very prominent. Therefore, exploring the failure behavior and mechanism of fretting corrosion fatigue damage has significant theoretical and practical significance.

At present, researchers in China and other countries mainly use equipment such as scanning electron microscope (SEM), optical microscope (OM), and transmission electron microscope (TEM) to observe and analyze surface morphology and fracture surfaces of wear spots and corrosion pits of fretting corrosion fatigue failure specimens. In this way, they can infer the mechanism of fretting corrosion fatigue damage. However, it is not possible to acquire the evolution law of wear spots and cracks during the fretting corrosion fatigue process solely through surface observation and study of destructive slices. Therefore, the mechanism of fretting corrosion fatigue damage in materials is still unclear. To study the evolution process of wear spots/corrosion pits and cracks in three-dimensional (3D) space during fretting corrosion fatigue, as well as the interaction between the corrosive medium and the fatigue load, it is necessary to observe the fretting corrosion fatigue process in situ in real time. In recent years, material characterization technology based on synchrotron radiation sources has developed rapidly. Due to its high brightness, high collimation, high polarization, narrow pulse and other characteristics, the material characterization technology can accurately capture the distribution characteristics of defects and microstructures in specimens at the sub-micron spatial scale and picosecond time scale. Therefore, the material characterization technology is a new type of ultra-high-resolution microscopy imaging technique that enables in-situ, dynamic, non-destructive and visual research on various material microstructures. Synchrotron radiation source imaging technology can be used for in-situ real-time observation of fretting corrosion fatigue damage and fracture processes and their evolution laws, which has irreplaceable scientific significance for accurate evaluation of material strength and life.

In addition, the presence of residual stress has a significant impact on the fatigue life of components. Usually, residual tensile stress can reduce fatigue life, while residual compressive stress can prevent crack initiation. Therefore, exploring the evolution law of residual stress in fretting corrosion fatigue is an important foundation for studying the fretting corrosion fatigue. Previous studies have shown that during fretting fatigue loading, the depth and width of residual stress in the fretting wear zone can reach several hundred microns. At present, there are various non-destructive detection methods available for characterizing and studying residual stress evolution, including laboratory X-ray diffraction (XRD), neutron diffraction (ND), synchrotron radiation diffraction, etc. Among them, the laboratory XRD method has poor penetration ability, with a penetration depth of generally about 10 microns, and cannot achieve in-situ characterization of the evolution law of residual stress inside the material. With a millimeter-scale resolution, the ND method cannot accurately measure residual stress distribution in micron-scale fretting wear zones. The resolution of synchrotron radiation XRD is adjustable between a few microns and several hundred microns, and it features high stability, high flux, micro beam diameter, quasi coherence, and stronger penetrability. Therefore, an in-situ fretting corrosion fatigue testing machine combining and compatible with a synchrotron radiation diffraction line station can effectively acquire the residual stress distribution and evolution law within a range from a few microns to a hundred microns in the fretting wear zone.

Currently, in the field of fretting corrosion fatigue testing, commercial fatigue testing machines on the market are mainly used in combination with specimen environments for testing. However, the commercial fatigue testing machines are bulky and heavy, and there are metal support arms and other components around the specimen, which do not meet the requirements of synchrotron radiation source imaging and diffraction. Therefore, the commercial fatigue testing machines cannot be directly used for synchrotron radiation sources.

### SUMMARY

A technical problem to be solved by the present disclosure is as follows.

In order to overcome the shortcomings of the prior art, the present disclosure provides an in-situ fretting corrosion fatigue testing machine and method for synchrotron radiation source imaging and diffraction. The present disclosure meets relevant conditions required for synchrotron radiation source experiments, thereby achieving real-time three-dimensional (3D) imaging characterization of wear spot and crack morphology of a material in a fretting corrosion environment, as well as characterization of a residual stress evolution law.

In order to solve the above technical problem, the present disclosure adopts the following technical solution.

An in-situ fretting corrosion fatigue testing machine based on synchrotron radiation diffraction and 3D imaging includes an axial fatigue loading system, a fretting loading system, and a corrosion environment control system, where
the axial fatigue loading system comprises a driving device, a load control device, and a load sensing device; the load sensing device is configured to measure an axial force and a normal force in real time; the driving device is configured to drive the load control device, thereby achieving axial displacement of the load control device; and the load control device is configured to carry out axial fatigue loading of a specimen;
the fretting loading system comprises a fretting wear device; the fretting wear device comprises two identical fretting pads that are symmetrical about a central axis of the specimen and horizontally positioned downward at a 45° angle; the two fretting pads are connected to two identical moving-magnetic voice coil motors respectively to achieve normal loading, such that the fretting pads maintain close contact with a surface of the specimen throughout an experimental process, ensuring that electromagnetic loading equipment cooperates with the two fretting pads to achieve fretting fatigue testing; and
the corrosion environment control system comprises an environmental control device and a data acquisition and control device; the environmental control device is configured to provide corrosion environments of full immersion, alternate immersion, and salt spray for the specimen; and the data acquisition and control device is configured to acquire measurement data and control the driving device.

In a further technical solution of the present disclosure, the axial fatigue loading system includes a base, an xy micro-displacement platform, an axial force sensor, a polymethyl methacrylate (PMMA) support cover, a lower fixture, an upper fixture, an electromagnetic loading device, an electric hydraulic cylinder, an upper end cover, an upper support rod, and a lower support rod; the xy micro-displacement platform is fixed to the base to ensure overall coaxiality of the testing machine after the specimen is clamped; the axial force sensor is provided at an upper end of the xy micro-displacement platform to monitor and acquire an axial loading force on the specimen; the lower support rod is fixed to the xy micro-displacement platform, and an upper end of the lower support rod is provided with the PMMA support cover; upper and lower sides inside the PMMA support cover are provided with the upper fixture and the lower fixture respectively to clamp the specimen; the upper support rod is provided above the PMMA support cover to support the upper end cover; the electromagnetic loading device is fixed to an upper end of the upper fixture to apply an axial force to the specimen, thereby achieving axial fatigue loading; the electric hydraulic cylinder is fixed above the electromagnetic loading device to control axial displacement of an upper end of the specimen in the axial fatigue loading system, facilitating replacement of the specimen.

In a further technical solution of the present disclosure, the fretting loading system includes the fretting pads, the moving-magnetic voice coil motors, and normal force sensors; two identical normal force sensors are respectively provided on tops of the fretting pads to monitor a fretting force applied by the fretting pads to the specimen; the two fretting pads are connected to the two identical moving-magnetic voice coil motors, respectively; the moving-magnetic voice coil motors are connected to a computer side; and through a computer input signal, the two fretting pads are controlled to produce normal displacement, ensuring that the fretting pads are in close contact with the specimen throughout a loading process to achieve fretting fatigue testing.

In a further technical solution of the present disclosure, a top height of the fretting pad is equal to a height of a fretting wear zone of the specimen.

In a further technical solution of the present disclosure, the environmental control device adopts a “bottom in and top out” circulation mode to creat the corrosion environments of full immersion, alternate immersion, and salt spray in a test chamber by controlling a state of a two-position four-way solenoid valve and a state of an inlet.

In a further technical solution of the present disclosure, the environmental control device is further configured to accelerate a corrosion rate by heating with a bundled electric heating tube and measure a temperature inside a corrosive solution chamber through a thermocouple, thereby achieving fretting corrosion fatigue damage testing.

In a further technical solution of the present disclosure, the corrosion environment control system includes an inlet, an upper outlet, a lower outlet, a corrosive medium chamber, a solution tank, an overflow valve, a filter, a hydraulic pump, a one-way valve, a two-position four-way solenoid valve, the bundled electric heating tube, the thermocouple, and a central processing unit; the two-position four-way solenoid valve includes two upper ports respectively connected to the inlet 4 and the lower outlet and two lower ports respectively connected to the one-way valve and the solution tank; the upper outlet is directly connected to the solution tank; the bundled electric heating tube is fixed to a lower chamber cover through a fastener; the lower chamber cover is provided with the thermocouple for monitoring a temperature inside the corrosive medium chamber; and the central processing unit is separately connected to the bundled electric heating tube, the thermocouple, an axial force sensor, a normal force sensor and an electric hydraulic cylinder to achieve uniform control by the central processing unit.

An in-situ fretting corrosion fatigue testing method based on synchrotron radiation diffraction and 3D imaging includes the following steps:
step 1: adjusting an xy micro-displacement platform after an upper fixture clamps a specimen, such that a lower fixture is aligned with a center of gravity of the specimen and clamps the specimen; adjusting an electromagnetic loading device, such that a height of the specimen in a vertical direction is adjusted to match appropriately with a height of an X-ray; accurately locating, by a laser positioning system, a testing position of the specimen, ensuring that the X-ray passes through an area of interest of the specimen via a PMMA support cover and is received by a ray receiver;
step 2: starting an environmental control device through a central processing unit; turning on a hydraulic pump and a bundled electric heating tube; measuring, by a thermocouple, a temperature inside a corrosive medium chamber, and transmitting data to the central processing unit; and turning off the bundled electric heating tube (29) when the temperature inside the corrosive medium chamber (15) reaches a test requirement, wherein a corrosive solution chamber is designed to provide three corrosion environment conditions: full immersion, alternate immersion, and salt spray;
step 3: starting fretting corrosion fatigue testing after setting up a corrosion environment; controlling axial movement of the electromagnetic loading device during testing by controlling an electric hydraulic cylinder, thereby achieving axial fatigue operation of the specimen; causing, by fretting pads, fretting wear on the specimen, leading to internal crack initiation in the specimen; and uploading, by an axial force sensor, acquired axial force data to a data acquisition card of the central processing unit through a signal line, and transmitting the acquired axial force data to a computer side for recording;
step 4: activating a light source X-ray emitting device without blocking the X-ray; controlling a light source turntable such that a main body of a testing device and the specimen in the main body rotate by 180°; allowing, during the process, the high-energy X-ray emitted by a light source to pass through the PMMA support cover and be received by an X-ray detector after passing through the specimen rotated 180°, thereby achieving image processing of the specimen at 180°; and reapplying a fatigue load to the specimen within a specified period, and repeating the above steps until the specified period of testing is reached; and
step 5: completing, for an imaging line station, the reconstruction of 3D morphology inside a material, and capturing a crack initiation and propagation process during fretting corrosion fatigue testing; and acquiring, for a diffraction line station, residual stress distribution information in a fretting wear zone of the material to explore an evolution law of a residual stress in fretting corrosion fatigue.

In a further technical solution of the present disclosure, in the step 2, the three corrosion environment conditions of full immersion, alternate immersion, and salt spray are specifically implemented as follows:
a) under a corrosion condition of full immersion: keeping a two-position four-way solenoid valve in an on state; opening an inlet, and closing a lower outlet; and forming a circulation loop of a corrosive solution in order of a solution tank, a filter, a hydraulic pump, a one-way valve, the inlet, the corrosive solution chamber, an upper outlet, and the solution tank;
b) under a corrosion condition of alternate immersion: controlling, by the central processing unit, the two-position four-way solenoid valve to be in a periodic on/off state; opening the inlet, and closing the lower outlet; and circulating the corrosive solution in a same method as in a); and
c) under a corrosion condition of salt spray: firstly, replacing the inlet with an atomizing nozzle; adjusting a flow rate of the hydraulic pump to a maximum flow rate, and adjusting a maximum pressure of an overflow valve to ensure testing safety; controlling, by the central processing unit, the two-position four-way solenoid valve to be in a periodic on/off state; atomizing, when the solenoid valve is turned on, the flowing corrosive solution by the atomizing nozzle, thereby creating a salt spray environment inside the corrosive solution chamber; and opening, when the solenoid valve is turned off, the lower outlet to discharge a solution bead formed by atomization back into the solution tank.

The present disclosure has the following beneficial effects:

The in-situ fretting corrosion fatigue testing machine and method based on synchrotron radiation diffraction and imaging technology provided by the present disclosure have the following advantages.
1. The present disclosure provides a lightweight and compact in-situ imaging mechanical loading testing machine for a fretting fatigue and corrosion coupled effect. The in-situ imaging mechanical loading testing machine has a small volume and a weight controlled within 20 kg (light weight). It can be well compatible with advanced light sources, meet the weight and size requirements of the specimen platform, and can rotate 180° with the light source rotation platform.
2. In the present disclosure, the electric hydraulic cylinder is used as a driving mechanism. The high-precision load sensor drives the electromagnetic loading system to produce axial displacement, achieving reciprocating cycling of the specimen. In addition, the fretting pads exert tangential stress on the surface of the specimen, resulting in fretting wear.
3. The fretting pads form a 45° angle with a horizontal direction, and the two ends of the fretting pad are relatively thin, ensuring that the synchrotron radiation source can easily penetrate the specimen during horizontal irradiation and ultimately provide a 3D imaging result.
4. By controlling the on/off state of the solenoid valve, the corrosion environment chamber of the testing machine can switch between three working states, which are independent of each other and do not interfere with each other, ensuring accurate results of fretting corrosion fatigue tests under various working conditions.
5. The heater adopts a bundled tubular electric heating element, which features fast thermal response, high temperature control accuracy, high comprehensive thermal efficiency, and high heating temperature.
6. The moving-magnetic voice coil motor can provide a static maximum load of ±750 N and a dynamic maximum load of ±1,250 N as an operating force, with a load accuracy of 0.001 N, and can provide a displacement stroke of 40 mm with a displacement accuracy of 0.1 μm. In addition, the moving-magnetic voice coil motor can provide an operating frequency of 0.001-50 Hz and maintain stable operation for a long time, clean and noise free.
7. The main structure of the testing equipment can rotate with the rotation of the synchrotron radiation source, and its pedestal is provided with a large-diameter circular hole, which facilitates the extraction of pipes and wires.
8. There are two sealing rings on the upper and lower parts of the corrosion chamber to prevent the leakage of the corrosive medium, ensuring an enclosed operating environment of the corrosion chamber, and enabling the testing machine to operate normally and efficiently so as to ensure accurate test results.

### BRIEF DESCRIPTION OF THE DRAWINGS

The drawings are provided merely for illustrating the specific embodiments, rather than to limit the present disclosure. The same reference numerals represent the same components throughout the drawings.

FIG. 1 is an overall structural schematic diagram of an in-situ fretting corrosion fatigue testing machine based on synchrotron radiation source diffraction and three-dimensional (3D) imaging;

FIG. 2 is an overall structural assembly diagram of the in-situ fretting corrosion fatigue testing machine based on synchrotron radiation source diffraction and 3D imaging;

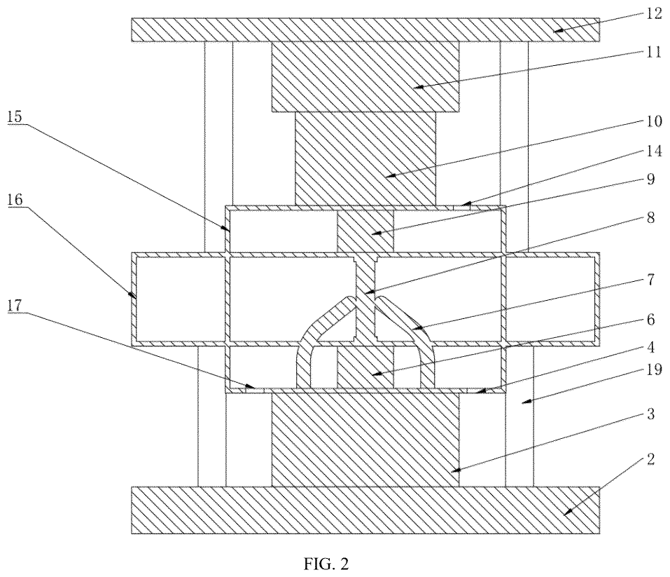

FIG. 3 is an overall structural 3D diagram of the in-situ fretting corrosion fatigue testing machine based on synchrotron radiation source diffraction and 3D imaging;

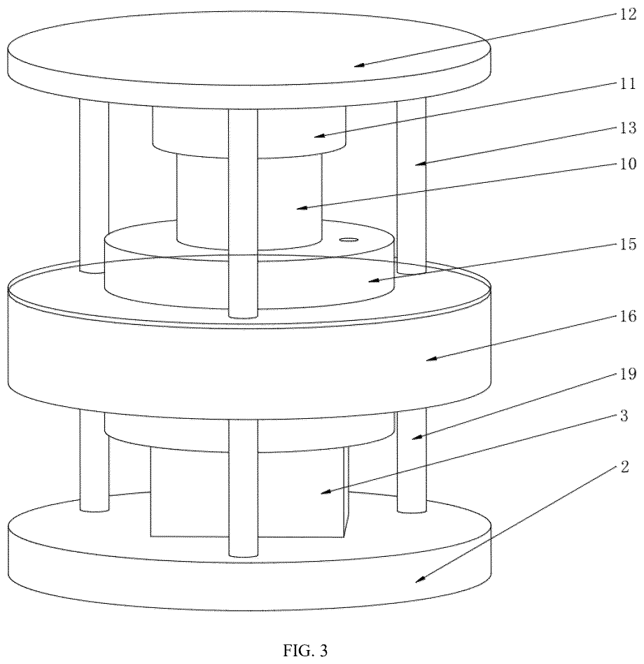

FIG. 4 is an internal exploded view of a corrosion chamber of the in-situ fretting corrosion fatigue testing machine based on synchrotron radiation source diffraction and 3D imaging; and

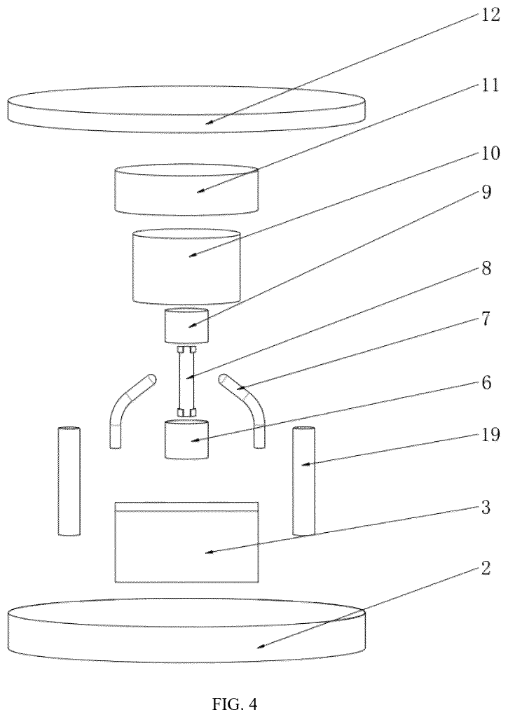

FIG. 5 is a piping diagram of the corrosion chamber of the in-situ fretting corrosion fatigue testing machine based on synchrotron radiation source diffraction and 3D imaging.

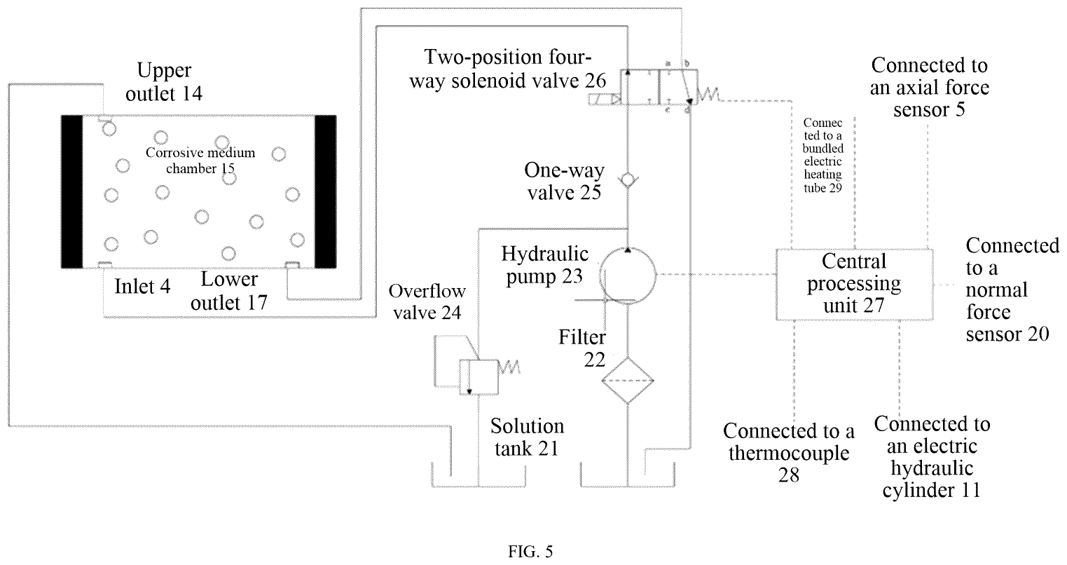

### REFERENCE NUMERALS

1. specimen turntable; 2. base; 3. xy micro-displacement platform; 4. inlet; 5. axial force sensor; 6. lower fixture; 7. fretting pad; 8. specimen; 9. upper fixture; 10. electromagnetic loading system; 11. electric hydraulic cylinder; 12. upper end cover; 13. upper support rod; 14. upper outlet; 15. corrosive medium chamber; 16. PMMA support cover; 17. lower outlet; 18. moving-magnetic voice coil motor; 19. lower support rod; 20. normal force sensor; 21. solution tank; 22. filter; 23. hydraulic pump; 24. overflow valve; 25. one-way valve; 26. two-position four-way solenoid valve; 27. central processing unit; 28. thermocouple; and 29. bundled electric heating tube.

### DETAILED DESCRIPTION OF THE EMBODIMENTS

To make the objectives, technical solutions, and advantages of the present disclosure clearer, the present disclosure is described in further detail below with reference to the drawings and embodiments. It should be understood that the specific embodiments described herein are merely intended to explain the present disclosure, but not to limit the present disclosure. Further, the technical features involved in the various implementations of the present disclosure described below may be combined with each other as long as they do not constitute a conflict with each other.

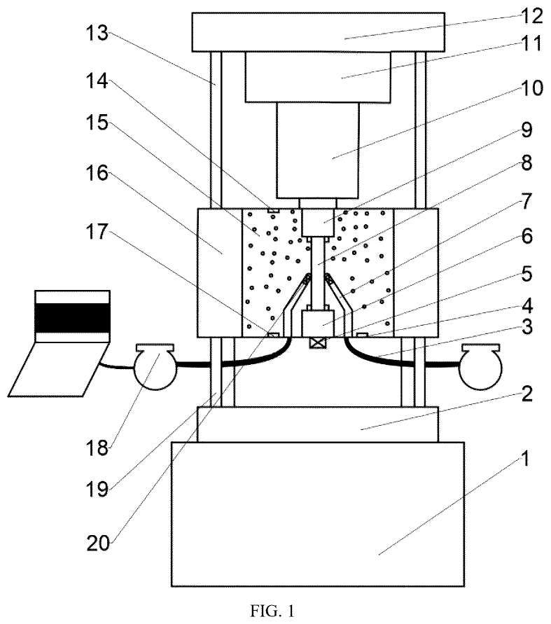

As shown in FIG. 1, the present disclosure provides an in-situ fretting corrosion fatigue testing machine based on synchrotron radiation diffraction and imaging technology, including a driving device, a load control device, a load sensing device, a fretting wear device, an environmental control device, and a data acquisition and control device. The in-situ fretting corrosion fatigue testing machine is an in-situ fretting corrosion fatigue testing device for real-time observation of a material damage evolution process under the coupling of fretting fatigue and corrosion. The load sensing device is configured to measure an axial force and a normal force in real time. The driving device adopts an electric hydraulic cylinder, and is configured to drive the load control device, thereby achieving axial displacement of the load control device. The load control device adopts an electromagnetic loading system, and is configured to carry out axial fatigue loading of a specimen, and connect the electric hydraulic cylinder to the electromagnetic loading system. The fretting wear device includes two identical fretting pads that are symmetrical about a central axis of the specimen and horizontally positioned downward at a 45° angle. The two fretting pads are connected to two identical moving-magnetic voice coil motors respectively to achieve normal loading, such that the fretting pads maintain close contact with a surface of the specimen throughout an experimental process, ensuring that the electromagnetic loading system cooperates with the two fretting pads to achieve fretting fatigue testing. The environmental control device adopts a “bottom in and top out” circulation mode to creat the corrosion environments of full immersion, alternate immersion, and salt spray in a test chamber by controlling a state of a two-position four-way solenoid valve and a state of an inlet. The environmental control device can further accelerate a corrosion rate by heating with a bundled electric heating tube, and use a thermocouple to measure a temperature inside a corrosive solution chamber, thereby achieving fretting corrosion fatigue damage testing. The data acquisition and control device simultaneously controls components such as the electric hydraulic cylinder, the solenoid valve, and the electric heating tube. The present disclosure conducts a synchrotron radiation in-situ three-dimensional (3D) imaging and diffraction experiment on a damage evolution behavior of a material during a fretting corrosion fatigue loading process. The present disclosure quantitatively measures an applied load through the load sensing device to acquire an evolution law of defect damage and residual stress inside the material with a cycle time during the fretting corrosion fatigue loading process. The present disclosure provides indispensable high-end technical equipment for revealing the fretting corrosion fatigue damage mechanism of the material.

The driving device, the load control device, and the load sensing device constitute an axial fatigue loading system. The fretting wear device constitutes a fretting loading system. The environmental control device and the data acquisition and control device constitute a corrosion environment control system. The axial fatigue loading system includes base 2, xy micro-displacement platform 3, axial force sensor 5, polymethyl methacrylate (PMMA) support cover 16, lower fixture 6, upper fixture 9, electromagnetic loading device 10, electric hydraulic cylinder 11, upper end cover 12, upper support rod 13, and lower support rod 19. The fretting loading system includes the fretting pads 7, the moving-magnetic voice coil motors 18, and normal force sensors 20. The corrosion environment control system includes inlet 4, upper outlet 14, lower outlet 17, corrosive medium chamber 15, solution tank 21, overflow valve 24, filter 22, hydraulic pump 23, one-way valve 25, two-position four-way solenoid valve 26, bundled electric heating tube 29, thermocouple 28, and central processing unit 27. The fretting loading system ensures that the fretting pads 7 and a surface of specimen 8 maintain close contact throughout the experimental process, and ensures that the axial fatigue loading system cooperates with the two fretting pads 7 to achieve fretting fatigue testing. Through the control of the corrosion environment control system, three corrosion environment conditions: full immersion, alternate immersion, and salt spray, are provided. The axial fatigue loading system and the fretting loading system cooperate to conduct the in-situ fretting corrosion fatigue testing. In the axial fatigue loading system, the xy micro-displacement platform 3 is fixed to the base 2 through a screw to ensure overall coaxiality of the testing machine after the specimen 8 is clamped. The axial force sensor 5 is provided at an upper end of the xy micro-displacement platform 3 to monitor and acquire an axial loading force on the specimen. The lower support rod 19 is fixed to the xy micro-displacement platform 3 through a screw, and an upper end of the lower support rod 19 is provided with the PMMA support cover 16. Upper and lower sides inside the PMMA support cover 16 are provided with the upper fixture 6 and the lower fixture 9, respectively, and the upper fixture and the lower fixture are fixed through screw to clamp the specimen 8. The upper support rod 13 is provided above the PMMA support cover 16 through a screw to support the upper end cover 12. The upper end cover 12 is connected to the upper support rod 13 through a screw. The electromagnetic loading system 10 is fixed to an upper end of the upper fixture 6 through a screw, and is configured to apply an axial force to the specimen, thereby achieving axial fatigue loading. The electric hydraulic cylinder 11 is fixed above the electromagnetic loading system 10 through a screw, and is configured to control axial displacement of an upper end of the specimen in the axial fatigue loading system, facilitating the replacement of specimen 8. In the fretting loading system, there are two identical fretting pads 7 symmetrical about the central axis of the specimen and horizontally positioned downward at a 45° angle. Two identical normal force sensors 20 are respectively provided on tops of the fretting pads 7 to monitor a fretting force applied by the fretting pads to the specimen. A top height of the fretting pad 7 is equal to a height of a fretting wear zone of the specimen. The two fretting pads 7 are connected to the two identical moving-magnetic voice coil motors 18, respectively. The moving-magnetic voice coil motors 18 are connected to a computer side. Through a computer input signal, the two fretting pads 7 are controlled to produce normal displacement, ensuring that the fretting pads 7 are in close contact with the specimen 8 throughout the loading process to achieve fretting fatigue testing. In the corrosion environment control system, the circulation of the corrosive solution adopts a “bottom in and top out” circulation mode. The corrosive solution is extracted from the solution tank 21 through a pipe, passes through the filter 22, the hydraulic pump 23, the two-position four-way solenoid valve 26, and the inlet to enter the corrosive medium chamber, and returns to the solution tank 21 from the lower outlet through a pipe. The inlet 4 and the lower outlet 17 are provided on a lower chamber cover. The upper outlet 14 is provided on an upper chamber cover, and the upper outlet 14 is configured to observe a solution height after the solution is stable. The overflow valve 24 is provided in a hydraulic pump branch to control a maximum pressure of the solution in a pipe, ensuring safety during testing. The inlet 4, the upper outlet, and the lower outlet each are provided with a rubber gasket for sealing. The two-position four-way solenoid valve 26 includes two upper ports respectively connected to the inlet 4 and the lower outlet 17 and two lower ports respectively connected to the one-way valve 25 and the solution tank 21. The upper outlet 14 is directly connected to the solution tank 21. The bundled electric heating tube 29 is fixed to the lower chamber cover through a fastener. The lower chamber cover is provided with the thermocouple 28 for monitoring a temperature inside the corrosive medium chamber. The central processing unit 27 is separately connected to the bundled electric heating tube 29, the thermocouple 28, the axial force sensor 5, the normal force sensors 20 and the electric hydraulic cylinder 11 to achieve uniform control by the central processing unit 27.

The testing machine is built as follows.
1) The xy micro-displacement platform 3 is placed above the base 2 and can achieve a planar micro-displacement relative to the base 2. Its function is as follows. When the specimen 8 needs to be aligned with the lower fixture 6 after it is fixed by the upper fixture 9, the base 2 is adjusted to make the planar micro-displacement, such that a center of gravity of the upper fixture coincides with that of the lower fixture, thereby avoiding inaccurate measurement of the specimen 8 due to eccentric loading.
2) On the base 2, the PMMA support cover 16 in the middle and the upper end cover 12 at a top are supported by the support rods. The upper end cover 12 is connected downward to the electric hydraulic cylinder 11, and the electric hydraulic cylinder 11 is connected downward to the upper fixture 9 to clamp the specimen 8. The specimen 8 is connected downward to the lower fixture 6. The lower fixture 6 is connected to the axial force sensor 5 to measure tensile and compressive loads on the specimen 8.
3) Specimen turntable 1 is a specimen rotation platform provided for a synchrotron radiation device. The base 2 is a pedestal of the testing machine that holds the specimen part. The specimen turntable 1 and the base 2 are separated from each other, but they are connected during testing. Therefore, the base 2 is provided on the specimen turntable 1.
4) The enclosed corrosive medium chamber 15 is provided inside the PMMA support cover 16. A lower end of the enclosed corrosive medium chamber 15 is provided with the fretting pad 7. Upper and lower ends of the fretting pad 7 are flat. A top part of the fretting pad is connected to the specimen 8 and forms a certain interference fit with the specimen 8. In addition, the top part of the fretting pad is tangent to the specimen 8, and is compressed to some extent. The specimen includes a lower end located on the lower fixture 6 and an upper end located on the upper fixture 9.
5) The inlet 4 is located at a lower right side of the corrosive medium chamber 15, and is connected to a pipe and a wire. Upper and lower left parts of the corrosive medium chamber 15 are provided with the upper outlet 14 and the lower outlet 17, respectively. The upper outlet 14 and the lower outlet 17 each are connected to a pipe and a wire through a same method as the inlet 4. The bundled electric heating tube 29 is provided inside the corrosion chamber to facilitate heating of the corrosive medium chamber 15.
6) An end of the fretting pad 7 is connected to the normal force sensor 20. The symmetrical fretting pads 7 are connected to the same normal force sensors. Tails of the fretting pads 7 are connected to the two moving-magnetic voice coil motors 18, respectively, and one of the two moving-magnetic voice coil motors is connected to the central processing unit 27 for data acquisition and control by the central processing unit 27. At this point, the building of the testing machine is completed.

The present disclosure further proposes a novel characterization method for in-situ fretting corrosion fatigue damage evolution through synchrotron radiation source diffraction and 3D imaging, including the following steps.
1) Firstly, according to the above-mentioned structural description of the in-situ fretting corrosion fatigue testing machine, the assembly and connection of each part are completed. The specimen turntable 2 is coaxial with an axis of a main body of the testing machine and the specimen 8 clamped without relative rotation, and is placed on a specimen testing platform of a light source imaging or diffraction line station.
2) After the upper fixture 9 clamps the specimen, the xy micro-displacement platform 3 is adjusted such that the lower fixture 6 is aligned with a center of gravity of the specimen and clamps the specimen. The electromagnetic loading device 12 is adjusted, such that a height of the specimen in a vertical direction is adjusted to match appropriately with a height of an X-ray. A laser positioning system is used to accurately locate a testing position of the specimen, ensuring that the X-ray passes through an area of interest of the specimen via the PMMA support cover 16 and is received by a ray receiver.
3) The environmental control device is started through the central processing unit 27. The hydraulic pump 23 and the bundled electric heating tube 29 are turned on. The thermocouple 28 measures the temperature inside the corrosive medium chamber 15 and transmits data to the central processing unit. When the temperature inside the corrosive medium chamber reaches a test requirement, the bundled electric heating tube is turned off. The designed corrosive solution chamber can provide three corrosion environment conditions: full immersion, alternate immersion, and salt spray.
a) Under the corrosion condition of full immersion, the two-position four-way solenoid valve is in an on state. At this point, the inlet 4 is open while the lower outlet 17 is closed. The corrosive solution forms a circulation loop in order of the solution tank, the filter, the hydraulic pump, the one-way valve, the inlet, the corrosive solution chamber, the upper outlet, and the solution tank.
b) Under the corrosion condition of alternate immersion, the central processing unit controls the two-position four-way solenoid valve to be in a periodic on/off state. At this point, the inlet is open while the lower outlet is closed. The circulation method of the corrosive solution is the same as that in the condition a.
c) Under the corrosion condition of salt spray, firstly, the inlet is replaced with an atomizing nozzle, a flow rate of the hydraulic pump is adjusted to the maximum, and a maximum pressure of the overflow valve 24 is adjusted to ensure the safety of the test. At this point, the central processing unit controls the two-position four-way solenoid valve to be in a periodic on/off state. When the solenoid valve is turned on, the atomizing nozzle atomizes the flowing corrosive solution, creating a salt spray environment inside the corrosive solution chamber. When the solenoid valve is turned off, the lower outlet is opened to discharge a solution bead formed by atomization back into the solution tank.
4) After the corrosion environment is set up, a fretting corrosion fatigue test begins. During the test, the axial movement of the electromagnetic loading system is controlled by controlling the electric hydraulic cylinder, thereby achieving axial fatigue operation of the specimen 8. Meanwhile, the fretting pad causes fretting wear on the specimen, leading to internal crack initiation in the specimen. The axial force sensor 5 uploads acquired axial force data to a data acquisition card of the central processing unit through a signal line, and then transmits the acquired axial force data to the computer side for recording.
5) A light source X-ray emitting device is activated without blocking the X-ray. The light source turntable 1 is controlled to rotate the main body of a testing device and the specimen 8 in the main body by 180°. During this process, the high-energy X-ray emitted by the light source passes through the acrylic support cover 16. After passing through the specimen 8 rotated 180°, the X-ray is received by an X-ray detector, thereby achieving 180° image processing of the specimen. A fatigue load is reapplied to the specimen within a specified period, and the above steps are repeated until the specified period of testing is reached.
6) After the test is completed, the central processing unit controls the electric hydraulic cylinder 11 to cause an axial displacement of the electromagnetic loading device, thereby achieving unloading of the specimen. Meanwhile, the screws of the upper fixture 9 and the lower fixture 6 are loosened, thereby removing the specimen 8.
7) For an imaging line station, the reconstruction of 3D morphology inside the material is completed to capture a crack initiation and propagation process during fretting corrosion fatigue testing. For a diffraction line station, residual stress distribution information in a fretting wear zone of the material is acquired to explore the evolution law of residual stress in fretting corrosion fatigue.

The above merely describes specific implementations of the present disclosure, but the protection scope of the present disclosure is not limited thereto. Any person skilled in the art can easily conceive various equivalent modifications or replacements within the technical scope of the present disclosure, and these modifications or replacements shall fall within the protection scope of the present disclosure.

1. An in-situ fretting corrosion fatigue testing machine based on synchrotron radiation diffraction and three-dimensional (3D) imaging, comprising an axial fatigue loading system, a fretting loading system, and a corrosion environment control system, wherein
the axial fatigue loading system comprises a driving device, a load control device, and a load sensing device; the load sensing device is configured to measure an axial force and a normal force in real time; the driving device is configured to drive the load control device, thereby achieving axial displacement of the load control device; and the load control device is configured to carry out axial fatigue loading of a specimen;
the fretting loading system comprises a fretting wear device; the fretting wear device comprises two fretting pads, wherein the two fretting pads are identical and symmetrical about a central axis of the specimen and horizontally positioned downward at a 45° angle; the two fretting pads are connected to two identical moving-magnetic voice coil motors respectively to achieve normal loading, such that the two fretting pads maintain close contact with a surface of the specimen throughout an experimental process, ensuring that electromagnetic loading equipment cooperates with the two fretting pads to achieve fretting fatigue testing; and
the corrosion environment control system comprises an environmental control device and a data acquisition and control device; the environmental control device is configured to provide corrosion environments of full immersion, alternate immersion, and salt spray for the specimen; and the data acquisition and control device is configured to acquire measurement data and control the driving device.

2. The in-situ fretting corrosion fatigue testing machine based on synchrotron radiation diffraction and 3D imaging according to claim 1, wherein the axial fatigue loading system comprises a base, an xy micro-displacement platform, an axial force sensor, a polymethyl methacrylate (PMMA) support cover, a lower fixture, an upper fixture, an electromagnetic loading device, an electric hydraulic cylinder, an upper end cover, an upper support rod, and a lower support rod; the xy micro-displacement platform is fixed to the base to ensure overall coaxiality of the in-situ fretting corrosion fatigue testing machine after the specimen is clamped; the axial force sensor is provided at an upper end of the xy micro-displacement platform to monitor and acquire an axial loading force on the specimen; the lower support rod is fixed to the xy micro-displacement platform, and an upper end of the lower support rod is provided with the PMMA support cover; upper and lower sides inside the PMMA support cover are provided with the upper fixture and the lower fixture respectively to clamp the specimen; the upper support rod is provided above the PMMA support cover to support the upper end cover; the electromagnetic loading device is fixed to an upper end of the upper fixture to apply an axial force to the specimen, thereby achieving axial fatigue loading; the electric hydraulic cylinder is fixed above the electromagnetic loading device to control axial displacement of an upper end of the specimen in the axial fatigue loading system, facilitating replacement of the specimen.

3. The in-situ fretting corrosion fatigue testing machine based on synchrotron radiation diffraction and 3D imaging according to claim 1, wherein the fretting loading system comprises the two fretting pads, the two identical moving-magnetic voice coil motors, and two identical normal force sensors; the two identical normal force sensors are respectively provided on tops of the two fretting pads to monitor a fretting force applied by the two fretting pads to the specimen; the two fretting pads are connected to the two identical moving-magnetic voice coil motors, respectively; the two identical moving-magnetic voice coil motors are connected to a computer side; and through a computer input signal, the two fretting pads are controlled to produce normal displacement, ensuring that the two fretting pads are in close contact with the specimen throughout a loading process to achieve fretting fatigue testing.

4. The in-situ fretting corrosion fatigue testing machine based on synchrotron radiation diffraction and 3D imaging according to claim 3, wherein a top height of the fretting pad is equal to a height of a fretting wear zone of the specimen.

5. The in-situ fretting corrosion fatigue testing machine based on synchrotron radiation diffraction and 3D imaging according to claim 1, wherein the environmental control device adopts a “bottom in and top out” circulation mode to creat the corrosion environments of full immersion, alternate immersion, and salt spray in a test chamber by controlling a state of a two-position four-way solenoid valve and a state of an inlet.

6. The in-situ fretting corrosion fatigue testing machine based on synchrotron radiation diffraction and 3D imaging according to claim 5, wherein the environmental control device is further configured to accelerate a corrosion rate by heating with a bundled electric heating tube and measure a temperature inside a corrosive solution chamber through a thermocouple, thereby achieving fretting corrosion fatigue damage testing.

7. The in-situ fretting corrosion fatigue testing machine based on synchrotron radiation diffraction and 3D imaging according to claim 6, wherein the corrosion environment control system comprises an inlet, an upper outlet, a lower outlet, a corrosive medium chamber, a solution tank, a one-way valve, a two-position four-way solenoid valve, the bundled electric heating tube, the thermocouple, and a central processing unit; the two-position four-way solenoid valve comprises two upper ports respectively connected to the inlet and the lower outlet and two lower ports respectively connected to the one-way valve and the solution tank; the upper outlet is directly connected to the solution tank; the bundled electric heating tube is fixed to a lower chamber cover through a fastener; the lower chamber cover is provided with the thermocouple for monitoring a temperature inside the corrosive medium chamber; and the central processing unit is separately connected to the bundled electric heating tube, the thermocouple, an axial force sensor, a normal force sensor and an electric hydraulic cylinder to achieve uniform control by the central processing unit.

8. An in-situ fretting corrosion fatigue testing method based on synchrotron radiation diffraction and 3D imaging, comprising the following steps:
step 1: adjusting an xy micro-displacement platform after an upper fixture clamps a specimen, such that a lower fixture is aligned with a center of gravity of the specimen and clamps the specimen; adjusting an electromagnetic loading device, such that a height of the specimen in a vertical direction is adjusted to match appropriately with a height of an X-ray; accurately locating, by a laser positioning system, a testing position of the specimen, ensuring that the X-ray passes through an area of interest of the specimen via a PMMA support cover and is received by a ray receiver;
step 2: starting an environmental control device through a central processing unit; turning on a hydraulic pump and a bundled electric heating tube; measuring, by a thermocouple, a temperature inside a corrosive medium chamber, and transmitting data to the central processing unit; and turning off the bundled electric heating tube when the temperature inside the corrosive medium chamber reaches a test requirement, wherein a corrosive solution chamber is designed to provide three corrosion environment conditions: full immersion, alternate immersion, and salt spray;
step 3: starting fretting corrosion fatigue testing after setting up a corrosion environment; controlling axial movement of the electromagnetic loading device during testing by controlling an electric hydraulic cylinder, thereby achieving axial fatigue operation of the specimen; causing, by fretting pads, fretting wear on the specimen, leading to internal crack initiation in the specimen; and uploading, by an axial force sensor, acquired axial force data to a data acquisition card of the central processing unit through a signal line, and transmitting the acquired axial force data to a computer side for recording;
step 4: activating a light source X-ray emitting device without blocking the X-ray; controlling a specimen turntable such that a main body of a testing device and the specimen in the main body rotate by 180°; allowing, during the process, the high-energy X-ray emitted by a light source to pass through the PMMA support cover and be received by an X-ray detector after passing through the specimen rotated 180°, thereby achieving 180° image processing of the specimen; and reapplying a fatigue load to the specimen within a specified period, and repeating the above steps until the specified period of testing is reached; and
step 5: completing, for an imaging line station, a reconstruction of 3D morphology inside a material, and capturing a crack initiation and propagation process during fretting corrosion fatigue testing; and acquiring, for a diffraction line station, residual stress distribution information in a fretting wear zone of the material to explore an evolution law of a residual stress in fretting corrosion fatigue.

9. The in-situ fretting corrosion fatigue testing method based on synchrotron radiation diffraction and 3D imaging according to claim 8, wherein in the step 2, the three corrosion environment conditions of full immersion, alternate immersion, and salt spray are implemented as follows:
a) under a corrosion condition of full immersion: keeping a two-position four-way solenoid valve in an on state; opening an inlet, and closing a lower outlet; and forming a circulation loop of a corrosive solution in order of a solution tank, a filter, a hydraulic pump, a one-way valve, the inlet, the corrosive solution chamber, an upper outlet, and the solution tank;
b) under a corrosion condition of alternate immersion: controlling, by the central processing unit, the two-position four-way solenoid valve to be in a periodic on/off state; opening the inlet, and closing the lower outlet; and circulating the corrosive solution in a same method as in a); and
c) under a corrosion condition of salt spray: firstly, replacing the inlet with an atomizing nozzle; adjusting a flow rate of the hydraulic pump to a maximum flow rate, and adjusting a maximum pressure of an overflow valve to ensure testing safety; controlling, by the central processing unit, the two-position four-way solenoid valve to be in a periodic on/off state; atomizing, when the solenoid valve is turned on, the flowing corrosive solution by the atomizing nozzle, thereby creating a salt spray environment inside the corrosive solution chamber; and opening, when the solenoid valve is turned off, the lower outlet to discharge a solution bead formed by atomization back into the solution tank.
